(19) United States
(12) Patent Application Publication
(10) Pub. No.: US 2002/0198910 A1
(43) Pub. Date: Dec. 26, 2002

(54) Apparatus and method for displaying component combinations in advertising media

(76) Inventor: Michael Meade, Pompano Beach, FL (US)

Correspondence Address: JOHN C. SMITH, ESQ., 4800 NORTH FEDERAL HIGHWAY, SUITE A-207, BOCA RATON, FL, 33431, US

(21) Appl. No.: 09/885,803

(22) Filed: Jun. 20, 2001

(51) Int. Cl. G06F 15/00

(52) U.S. Cl. 707/517; 707/500

(57) ABSTRACT

A catalog containing images of available caps are displayed on pages of a catalog. The images of available visors are arranged on the periphery of other removable pages. The page containing visor images is moved from one cap image to another until the most desirable combination of caps and visors is determined. The page holding the visor images can be a single strip that is smaller than the page holding the cap images. Alternatively, a transparent sheet holds images of multiple visors and is moved over the page having images of caps until the most desirable combination of caps and visors is determined. Alternatively, an image “slide rule” which has one side having cap images and another slide having visor images is used. The two sides are slidably secured to one another such that they can be moved to align a cap image with multiple images of visors. The slide rule can be linear or circular. The images can optionally be presented by a central computer having a library of cap and visor images which allows caps and visors to be independently selected, combined by the computer into a single image, and then displayed on the customer's computer monitor.

### BACKGROUND OF THE INVENTION

1. Technical Field

The present invention relates to methods of displaying combinations of garment components in advertising media. In particular, it relates to mechanical and/or electronic display of components of garments which allows a customer to dynamically combine components together for the purpose of selecting color or material combinations.

2. Background Art

The use of multiple materials in garments, especially in hats or head wear, is widespread. In particular, it is fairly common for an individual to wear a baseball-type hat that has a cap portion that fits on the user's head, and a visor located on the front edge of the cap. Frequently, this type of cap is made with the cap fabricated from one color while the visor is fabricated from another. Likewise, the materials used to fabricate the cap does not have to be the same materials used to fabricate the visor.

Conventional catalogs used to select a particular type of hat either show the cap completed and the combinations available, or it leads the purchaser to understand that the purchaser can make their own cap and visor combination. When customers select a particular combination of cap and visor for purchase, whether they be merchants purchasing from a manufacturer or consumers purchasing from a retail store, the selection process typically involves reviewing a large catalog which has numerous combinations to choose from. While the catalog may have a substantial number of items, it is still very likely that a large number of desirable combinations of caps and visors which would appeal to a customer would not be shown in the catalog. Even if the specific types of caps and visors are shown, they are typically in the catalog where the purchaser would not see them in combination. Due to the size of the catalog, the selection task is generally cumbersome and inconvenient for the purchaser.

In most catalogs, the purchaser is informed that they are able to choose the shape, the type of material, the color, the rear closure, and any other type of options such as braid or special visor. Unfortunately, while conventional catalogs may inform the purchaser that they can configure the hat to their own specifications, the catalog does not provide any convenient means for purchaser to see how a custom-made hat, which does not already appear in the catalog, will look as a completed unit. It would be desirable to provide a purchaser with an easy and convenient method of comparing a large number of combinations without having the inconvenience and burden of using a large catalog.

In addition to the issue of inconvenience, discussed above, prior art catalog systems also have another disadvantage in that they are generally very costly. In order to provide a large selection, the catalog must be a substantial document which is expensive to produce. It would be desirable to have a small catalog which is easy to handle and manipulate, but would at the same time provide a large number of combinations for the customer to consider.

Catalog systems also have the disadvantage of being difficult and costly to change. In the event that one or more new styles are produced, the entire catalog may have to be reproduced to accommodate their inclusion. It would be desirable to have method of making minor changes to a catalog without replacing the entire catalog.

With the advent of e-commerce, many types of retailing and sales techniques, such as the use of catalogs, have been adapted for use on the Internet. Unfortunately, voluminous amounts of information, such as that found in catalogs, would be unwieldy in an environment where substantial amounts of data must be transferred via telephone lines in order to present an image of the catalog on a computer screen. It would be desirable to have a method of downloading catalog data to a computer such that large combinations of caps and visors can be displayed on the computer without requiring large data transfers.

While addressing the basic desirability of providing customers with the means to select from a variety of choices, the prior art has failed to provide a method in which the customer can be presented with a large number of choices from a small sample set, in which the customer can use a physically small and convenient catalog, which is inexpensive to manufacture and/or modify, and which can be implemented on a computer such that small data transfers will provide a customer with a wide selection of choices.

### SUMMARY OF THE INVENTION

The present invention solves the foregoing problems by providing a template system in which visor image templates are used in conjunction with catalog pages showing images of caps. The visor images are arranged on the periphery of a template which the customer moves in relation to the page containing cap images such that the visor images are moved from one cap image to another. The customer moves the images in this manner until the most desirable combination of caps and visors is determined. The page holding the visor images can optionally be a single strip that is smaller than the page holding the cap images.

An alternative embodiment provides a transparent template sheet which holds images of multiple visors. The transparent template sheet is moved over the page having cap images until the most desirable combination of caps and visors is determined.

Another alternative embodiment provides an image “slide rule” which has a base portion displaying cap images and a movable visor template which displays visor images. The two components are slidably secured to one another such that they can be moved to align a cap image with multiple images of visors. The slide rule can be linear or circular.

In another alternative embodiment, a central computer having a library of cap images and visor images allows caps and visors to be independently selected, combined by the computer into a single image, and then displayed on the customer's computer monitor. When the customer selects the desired combination, the system accepts the approved customer specifications and issues the appropriate fabrication order to the manufacturer or reseller.

### BRIEF DESCRIPTION OF THE DRAWINGS

FIG. 1 illustrates a prior art catalog page having multiple hats that illustrate possible combinations of caps and visors.

FIG. 2 illustrates a preferred embodiment of the catalog page from template system in which unique cap styles are arranged on the catalog page.

FIG. 3 illustrates a preferred embodiment of the template with visor images arranged around the edge of the template.

FIG. 4 illustrates a preferred embodiment of the template with visor images arranged around the edge of the template and the outer edges of the visor images trimmed such that the visor is located at the edge of the template.

FIG. 5 illustrates a preferred embodiment of a transparent template with visor images arranged across the entire surface of the template.

FIG. 6 is another preferred embodiment which illustrates the use of a linear slide rule to display combinations of caps and visors.

FIG. 7 is yet another preferred embodiment in which illustrates the use of a circular slidable to display combinations of caps and visors.

FIG. 8 is another preferred embodiment in which the template system is implemented by computer software.

FIG. 9 is a preferred embodiment which illustrates the proper positioning of the cap and relation to the visor when used with the template system.

### DESCRIPTION OF THE PREFERRED EMBODIMENT

Prior to a detailed discussion of the figures, the general overview of the template system disclosed herein will be provided. The template system is an improvement to conventional catalog systems in which a limited number of combinations of caps and visors are shown, and which allow the purchaser to make other combinations which the catalog does not show. The most important feature of the template catalog is its ability to let the customer actually see a completed hat, which can be fabricated from any combination of cap and visor, before it's ordered. The template system is unique because it allows the user to move every type and color of visor to any cap, thereby providing a clear picture of every combination that is available. The template system provides the user the ability to create and see not only every available color combination, but also to see every fabric combination that is available.

In a conventional catalog, the need to show multiple combinations means that the image of a particular type of cap or visor may be reproduced many times. As a result, a conventional catalog tends to be voluminous, which results and high production costs and substantial inconvenience to the user due to catalog bulk. In contrast, the template system shows a particular type of cap or visor only once. This provides a substantial reduction in the size of the catalog while maintaining its ability to show not only all of the combinations displayed by a conventional catalog, but also to show combinations which do not appear in the conventional catalog. This reduces the cost of production of the catalog, and substantially improves its ease-of-use. The template system provides the purchaser the ability to create and see any color and fabric combination in a convenient manner which greatly reduces the time needed to select a hat combination, and greatly increases the convenience of use to the purchaser. As a result, the template system is a selling tool which increases sales by making it easier for a purchaser to select an item, and which increases sales cost by reducing the amount of time needed by a purchaser to select an item. Headwear products, as with all other products, if a purchaser can see the product, the purchaser is more likely to make a better informed buying decision. This will result in faster sales, reduced returns, and repeat sales.

In practice, a purchaser will first review the pages holding cap images until the most desirable cap style and materials are found. Then, the purchaser moves the visor template over the selected caps to see which is the most desirable combination for them. For ease of ordering, the order number for each cap style is displayed with its image on the page. Likewise, the order number for each visor style is displayed with its image on the template. As a result, when the desired combination is found, the order numbers are conveniently available to complete the order process.

In the preferred embodiment, the template sheets and the cap image pages are substantially the same size. However, this is not important to implement the template system invention. For example, multiple worlds of caps can be displayed on a single page while visors can be displayed in narrow strips holding a single row of visors. The visor template must merely be movable in relation to the cap image page to implement the invention. In the case where the template is not transparent, the visor template would typically have the visors arranged around the periphery of the template. In this situation, the hat image produced by aligning the template with the cap image page will be improved if the edge of the template visor is cut out such that the edge of the visor which comes in contact with the edge of the cap is on the edge of the template. Of course, if the template sheet is transparent, then the visor images can be located anywhere on the template, and the template can be conveniently made from a rectangular sheet.

Is also possible, instead of using mere images of the caps and visors, to use actual samples of the fabrics or materials used to produce the hats. The actual materials will of course be a little more cumbersome than images, but they provide a purchaser with a more complete understanding of the product they are buying.

Alternatively, the visor template and the cap image page can be replaced with the slide rule device which is more convenient to use than a catalog, but has a reduced number of possible combinations. When mechanical slide rule devices are used, one segment contains cap images, while the second segment contains visor images. These segments are slidably joined so that the visor and cap images are slidably moved in relation to one another and automatically align with one another as they pass one another. The slide rule device can take any convenient slide rule form. For example, it can take the form of a bar shape as was historically used for mathematical slide rules, or it can be created as a circular slide rule in which an inner wheel rotates in front of an outer wheel.

Typically, the components of the slide rule are permanently attached to one another. This has a disadvantage in that there are a limited number of cap and visor styles which may conveniently fit on the slide rule. Of course, if the components of the slide rule were separable, then template components or cap image components could be substituted to provide an expanded number of potential combinations. The template system, discussed above, is not limited because there is no limit on the number of cap image pages or visor templates. Be that as it may, for certain applications, the slide rule display may be perfectly adequate. For example, when selling hats related to sports teams, there are typically a limited number of colors and styles which are related to a limited number of teams. In this situation, it is possible that all of the available combinations can be shown on a slide rule.

The mechanical template system, discussed above, can also be implemented in software with the results displayed on a computer terminal. The advantage of using the template system in conjunction with computer software, as opposed to using computer software to merely display a conventional catalog, is that display of items from a conventional catalog can be very time and resource intensive. This is due to the amount of data that must be transferred from a server computer to an individual's computer when the individual is seeking to execute an e-commerce transaction, such as it is commonly done via the Internet. The template system allows the user to reduce data flow by sending data related to a particular cap style to the user's computer only once. Likewise, data related to a particular visor style is also transferred only once. This substantially increases the speed of an e-commerce transaction for this type of selection process, and avoids the situation where the user terminates the purchase due to frustration caused by slow computer performance.

Another advantage provided by the template system is that it is easier to update a catalog when changes are made to available inventory. In prior art catalogs, the addition of a new item or the deletion of an old item would require reprinting the entire catalog. This not only engendered unnecessary printing costs, but it also maximized shipping costs for shipping the new catalogs to vendors or customers. The template system reduces the impact of changes by requiring only replacement of changed pages or templates. This reduces both printing and shipping costs.

As a result of using the template system, several advantages are provided. First, convenience is provided to the purchaser by allowing the purchaser to rapidly and easily locate the most desirable cap and visor styles. Second, sales efficiency is increased by reducing the amount of time required for the purchaser to make a selection. Third, updates to the catalog are greatly reduced in cost by requiring only replacement of the changed portions of the catalog. Fourth, alternative catalog structures can be used, such as slide rule devices, which would not be possible without the template system. Fifth, e-commerce sales can be made more convenient by reducing the amount of data that has to be transferred. We turn now to a more detailed discussion of the figures.

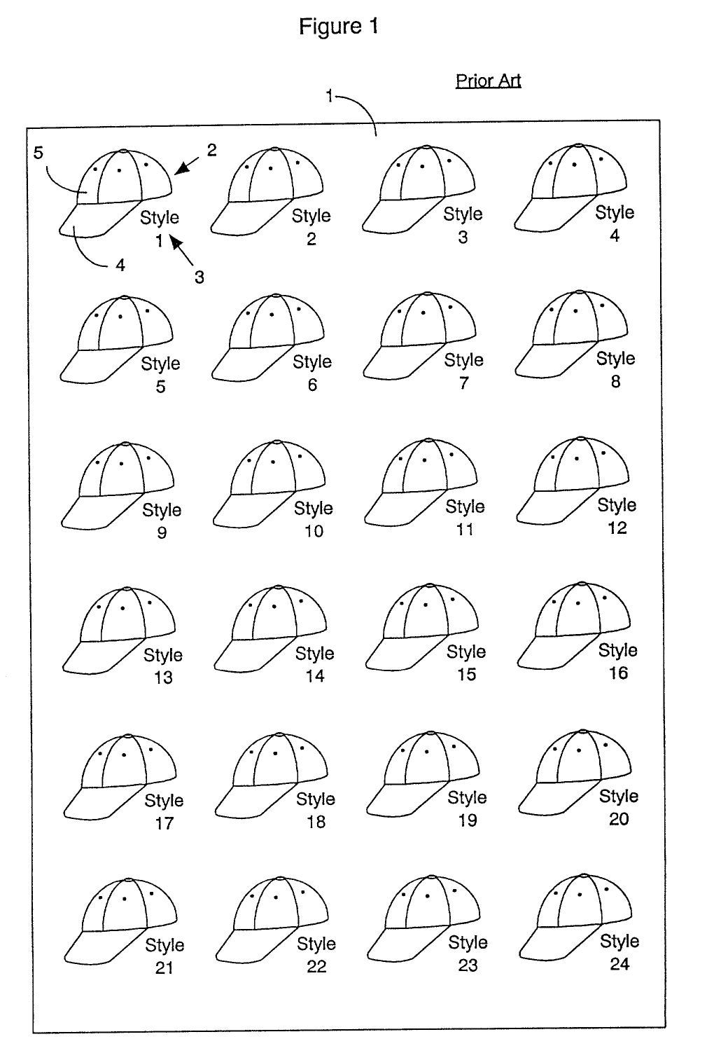

Referring to FIG. 1, this figure shows a typical prior art catalog page 1. The catalog page 1 will hold a plurality of hat images 2 and the style numbers 3 associated with each hat image 2. Each hat 2 is displayed as a complete unit having a cap 5 and a visor 4. Typically, each hat 2 would display a unique combination of cap 5 and visor 4 styles. Typically, the pages of the catalog will be organized by types of hats 2. For example, several pages may be devoted to hats 2 fabricated from cotton twill, several pages may be devoted to hats 2 made from oil/wax cotton, several pages may be devoted to hats 2 made from Chino cotton twill, etc. As a result, not only can duplicate images appear for the same types of fabrics, duplicate images may also appear for caps 2 which have the identical color and appearance but are made from different fabrics.

This redundancy creates a substantial drawback for prior art catalogs because, if the catalog shows every possible combination of caps 5 and visors 4, then the size of the catalog can become voluminous. In addition, depending on the number of combinations which the publisher chooses to include, a particular style of cap 5 or a particular style of visor 4 may show up many times in the catalog. This redundancy greatly increases the size of the catalog, thereby adding to its cost of production, increasing the time and inconvenience it takes for a purchaser to examine its contents. Likewise, a change related to a single hat 2, such as the deletion of an existing hat 2 style or the addition of a new hat 2 style, would require that the entire catalog be replaced. Since catalogs are typically printed on a set schedule, changes to a product line may not effectively be conveyed to vendors or the public in a timely fashion.

As will be shown below, in regard to the template system, each cap 5 style and visor 4 style only needs to be included a single time within the catalog. This will greatly reduced the size of the catalog, making it more convenient to handle. In addition, the cost of production will be reduced, and sales time will be reduced because the purchaser can examine the catalog in a reduced amount of time.

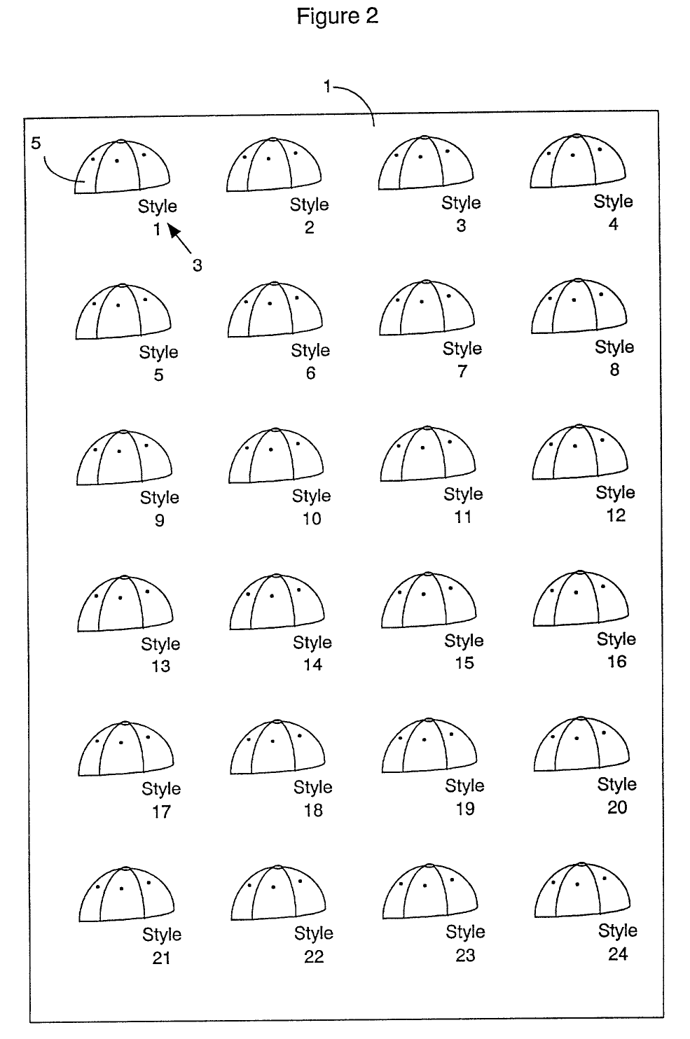

In FIG. 2, a preferred embodiment of catalog page 1 modified for the template system is shown. In this figure, the visors 4 have been eliminated. In addition, each cap 5 style appears only once, which eliminates any redundancy. As a result, the number of pages required for a large selection of hats 2 is greatly reduced.

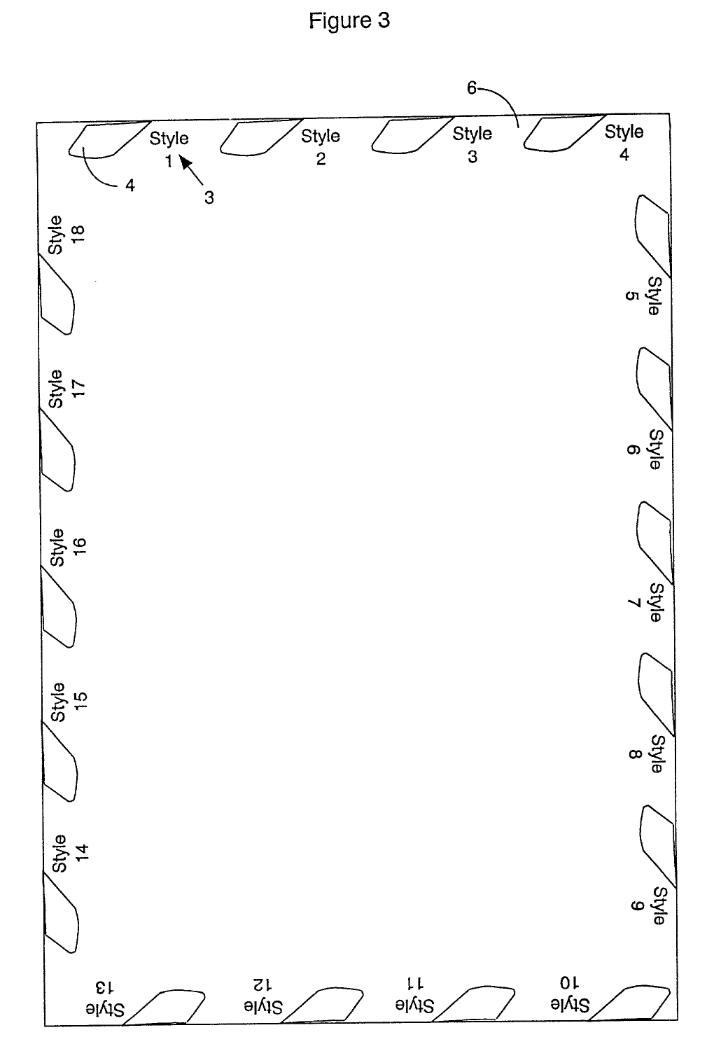

Those skilled in the art will recognize that the visors 4 may optionally remain on the catalog page 1. For example, the catalog page 1 may illustrate caps 5 and visors 4 which have the same color and fabric. In that case, the purchaser may see what a single fabric hat 2 would look like without the need to use the template (shown below in regard to FIG. 3). When the template is used, the visors 4 on the template would conceal the visors 4 on the catalog page and allow the purchaser to view the cap 5 with a different visor 4.

FIG. 3 illustrates a preferred embodiment of the template 6 used in conjunction with the modified catalog page 1 (discussed above in regard to FIG. 2). In this template, the periphery of the template 6 as a plurality of visors 4. Each of visors 4 is unique in regard to the other visors 4. When a purchaser is deciding which cap 5 and visor 4 combination to select, the purchaser aligns the edge of the template 6 with the cap 5 images on the modified catalog page 1. Once the purchaser has determined which cap or caps 5 are desired, then the template 6 can be aligned with the caps 5 and moved such that the cap 5 can be aligned with as many visors 4 as the purchaser desires. As a result of using this template 6, many more cap 5 and visor 6 combinations can be shown than would be possible with a conventional catalog page. For example, using a mere 215 caps 5 in combination with only 180 visors 4 creates a total of 38,700 unique combinations of caps 5 and visors 4 can be shown with approximately sixteen catalog pages 1 and ten templates 6. Of course, the number of visors 4 placed on the template 6 and the number of caps 5 placed on the catalog page 1 can vary. Therefore, the number of possible combinations can vary. In contrast, to display the same number of combinations in a conventional catalog system would require 774 pages with 50 hats per page. If the pictures of caps were as large as what is possible to show in sixteen catalog pages 1 and ten templates 6, then the conventional catalog would require 1,935 pages. As can be seen, the template system provided herein has a drastic effect on the cost of producing catalogs. In addition, it provides a system which is much easier for a consumer to use, and a system which allows a consumer to much more rapidly determine which cap 5 and visor 4 combination is the most desirable for that consumer.

Those skilled in the art will recognize that the reason for arranging the visors 4 around the periphery of the template 6 would be because the template 6 is not transparent.

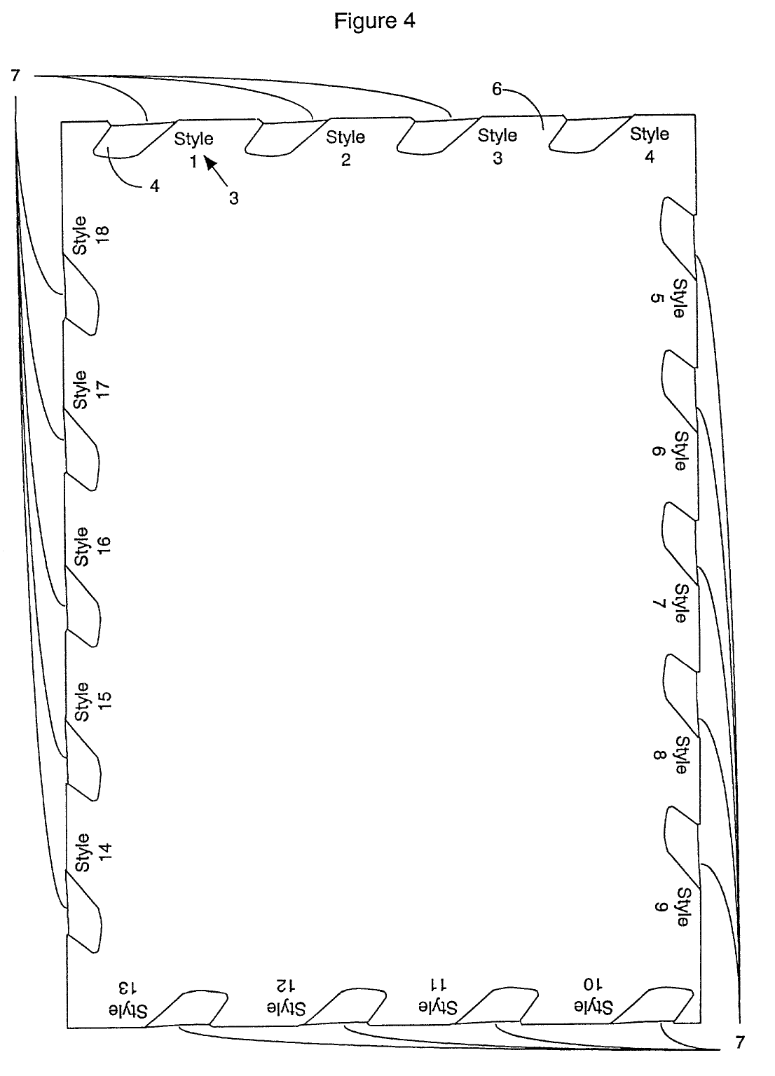

FIG. 4 is another preferred embodiment of the template 6. This embodiment differs from the embodiment of FIG. 3 in that the edge of the template 6 is trimmed such that the edge 7 follows the outer edge of the visor 4 at the edge of the template 6. This permits the visor 4 to more precisely aligned with the cap 5 on the catalog page 1.

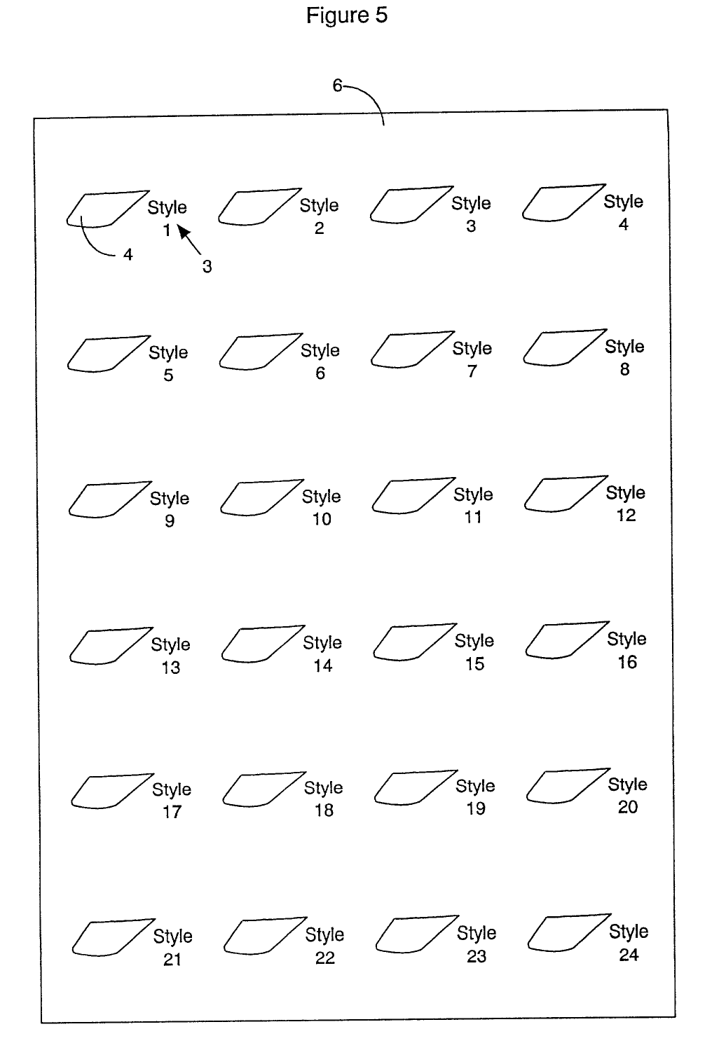

FIG. 5 is another preferred embodiment of the template 6. It in this embodiment, the template 6 is fabricated from transparent material which will allow the catalog page 1 and the caps 5 to be seen through the template 6 when the template 6 is placed on top of the catalog page 1. This embodiment has several advantages. First, the visor 4 images do not have to be carefully aligned with the edges of template 6 when produced. Second, the edges of the template 6 do not have to be trimmed as they were in FIG. 4. Third, since the visor 4 images do not have to be located on the edges of the template 6, the entire area available on template 6 can be used to display visor 4 images. This allows a substantial increase in the number of possible combinations that can be made using a single template 6.

Those skilled in the art will recognize that any suitable material can be made to fabricate template 6. The only requirement is that the material be sufficiently transparent to allow the caps 5 on the catalog page 1 to be clearly seen through the template 6.

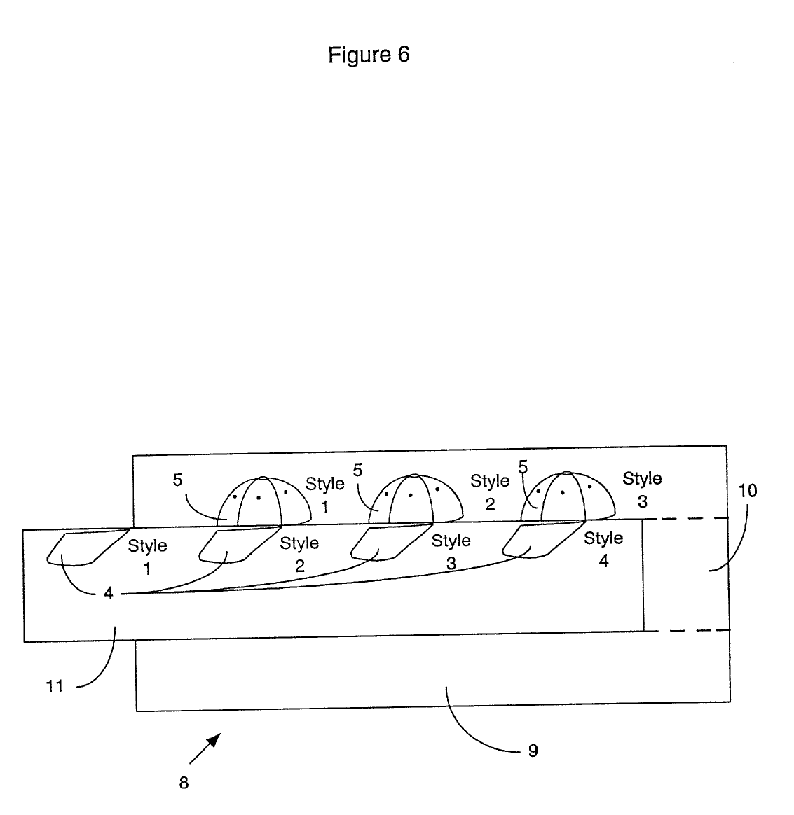

In FIG. 6, an alternative preferred embodiment is shown. This embodiment uses a mechanical slide rule structure to combine cap 5 styles with a variety of visor 4 styles. In this embodiment the slide rule 8 has a plurality of caps 5 in fixed locations on the base 9 of the slide rule 8. A sliding member 11 moves horizontally along track 10. Each visor 4 can be moved to align with any cap 5. Those skilled in the art will recognize that the number of caps 5 and visors 4 will be controlled by the length of the slide rule 8 and the size of the caps 5 and the visors 4 in relation to the slide rule 8. Of course, the catalog based template system described above can hold more possible combinations. However, the slide rule display can be very useful for promotional items which do not carry a large number of combinations (e.g. the limited number of sports team combinations discussed above).

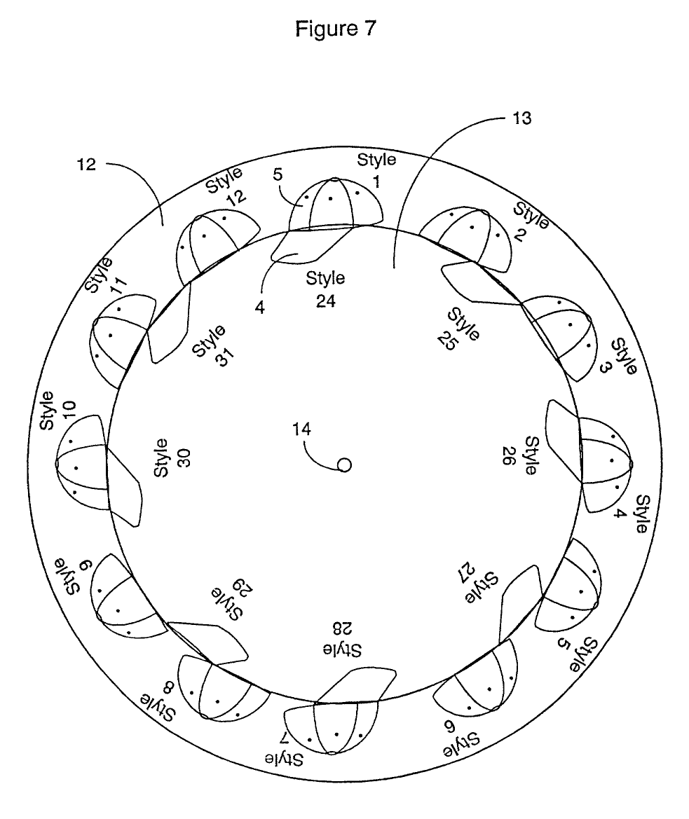

Regarding FIG. 7, this figure is another alternative preferred embodiment which uses a circular slide rule to display combinations of caps 5 and visors 4. In this embodiment, a rear disk 12 has a number of caps 5 arranged around its periphery. A front disk 13 is rotatably attached to a rear disk 12 at that pivot point 14. As the front disk 13 is rotated in relation to the rear disk 12, the visors 4 on the front disk 13 are moved from one cap 5 to another on the rear disk 12. As can be seen from this figure, it is not necessary to have an equal number of visors 4 and caps 5. As was that case above, in regard to be linear slide rule, this slide rule would carry a limited number of combinations, but it may be very useful for promotional or special-interest lines of hats, etc. As was the case with previous embodiments, the style numbers for the caps 5 and visors 4 are conveniently located on the disks 12 and 13.

Those skilled in the art will recognize that it is possible to build a slide rule in which the rear disk 12 and the front disk 13 can be disengaged and combined with other disks having other caps 5 or visors 4.

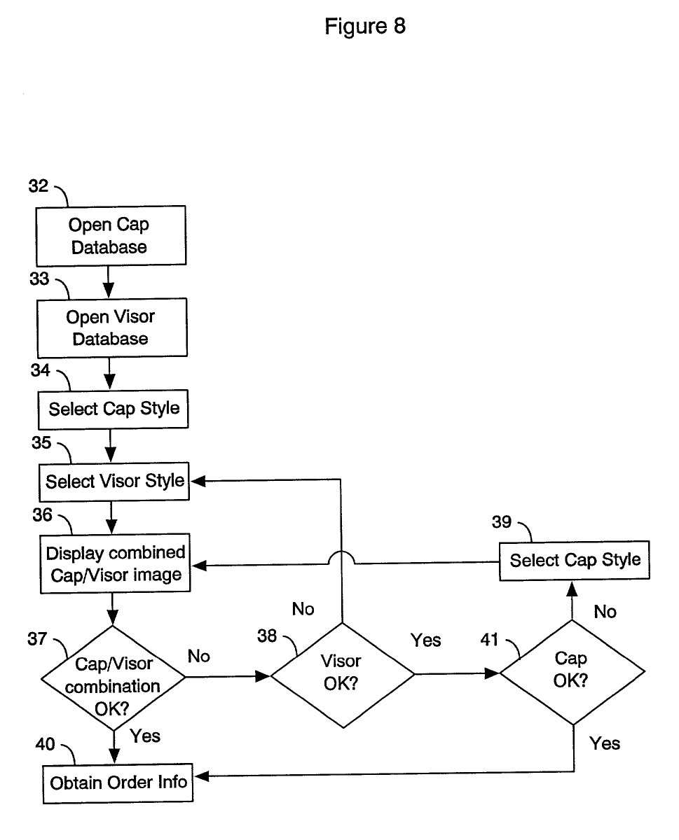

Regarding FIG. 8, this figure illustrates a preferred embodiment of the template system in which a programmable computer is used to display the caps 5 and visors 4. In this embodiment, a computer first opens a cap 5 database at step 32, and opens a visor 4 database at step 33. The user browses through images of caps 5 which are displayed on the computer's display screen and selects a cap 5 style at step 34. Once the cap 5 style is selected, the user then browses through images of visors 4 and selects a visor 4 style at step 35. At step 36, the computer displays a combined image of this selected cap 510 visor 4 which shows how the resulting hat would look. If the user determines, at step 37, that the combination is okay, then the computer would proceed to obtain order information at step 40 by known means. On the other hand, if the cap 5 and visor 4 combination is not found to be acceptable at step 37, then the computer queries the user, at step 38, to determine if the visor 4 is acceptable. If the visor 4 is not acceptable, then the computer returns to step 35 and repeats the visor 4 selection process. If the visor 4 is acceptable, then the computer queries the user to select a new cap 5 style. Once an acceptable cap 5 is found, then the system proceeds to obtain order information at step 40.

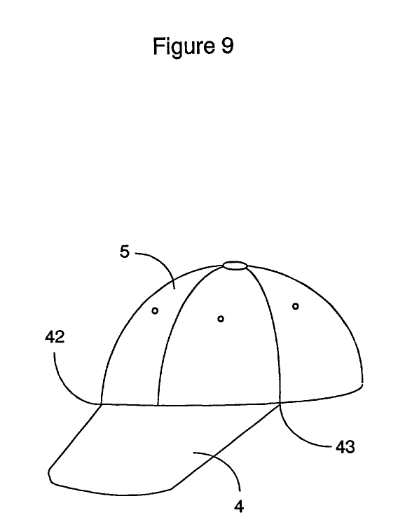

FIG. 9 illustrates the proper positioning to the cap 5 in relation to the visor 4. To best display the combination of a cap 5 and a visor 4, it has been found that if the edge of the cap 5 and visor 4, as illustrated by the line which extends between point 42 and point 43, are photographed from an angle such that it is substantially flat, then the visors 4 on the edge of the template will align properly across the entire line and provide the best possible display of a cap 5 and visor 4 combination. Of course, this visual technique will also work with embodiments such as the slide rule embodiment or the computer display embodiment.

The foregoing embodiments have all shown the template system used in conjunction with hats 2. In particular, the use of a plurality of first images, namely caps 2, is in conjunction with a plurality of second images, namely visors 4. When the caps 2 and the visors 4 are displayed together, they form a complete object, namely a hat 2. However, those skilled in the art will recognize that the template system disclosed herein can be used in relation to a variety of other objects in which first and second images can be changed in relation to one another, such as garments (e.g. ties and shirts), etc.

While the invention has been described with respect to a preferred embodiment thereof, it will be understood by those skilled in the art that various changes in detail may be made therein without departing from the spirit, scope, and teaching of the invention. For example, the number of caps on the page can vary, the number of visors on a template can vary, the material used constructed the template can vary, the size and shape of the template can vary, the slide rule can vary in shape and or size, etc. Accordingly, the invention herein disclosed is to be limited only as specified in the following claims.

I claim:

1. A catalog template system, further comprising:
at least one catalog page having a first plurality of images, each image in the first plurality of images representing a first part of a complete object;
at least one template page having a second plurality of images, the second plurality of images related to the first plurality of images, and each image in the second plurality of images representing a second part of a complete object;
means to select one of the first plurality of images, and one of the second plurality of images; and
means to display the images selected from the first plurality of images and the second plurality of images such that they combined to create an image of a complete object;
whereby images from first and second pluralities of images can be selectively combined with one another to produce a number of images of complete objects.

2. A system, as in claim 1, wherein:
the second plurality of images on the template page arranged around the periphery of the template page and sized such that when the edge of the template page is aligned with a selected image from the first plurality of images on the catalog page, at least one of the images from the second plurality of images aligns with the
selected image from the first plurality of images to form an image of a complete object;
whereby images from the first and second plurality of images can be selectively combined to form an image of a complete object.

3. A system, as in claim 2, wherein:
the edges of the template page is trimmed such that the edges of the selected images arranged around the periphery of the template page are substantially on the edge of the template page;
whereby the template page is trimmed to allow the first and second images, when combined to form a complete object, to more accurately align with one another.

4. A system, as in claim 1, wherein:
the template page is fabricated from material which is substantially transparent; and
the second plurality of images arranged on the template page such that when the template page is placed on top of the catalog page, and an image from the catalog page is aligned with an image from the template page goes to images will create the image of a complete object;
whereby substantially all of the surface area of the template page is available to display images from the second plurality of images.

5. A system, as in claim 1, wherein:
the images in the first and second plurality of images are printed images.

6. A system, as in claim 1, further comprising:
the images in the first and second plurality of images are fabricated from the same material that the complete object is fabricated from;
whereby the complete object can be seen and felt at as it appears after fabrication.

7. A system, as in claim 6, wherein:
the second plurality of images on the template page arranged around the periphery of the template page and sized such that when the edge of the template page is aligned with a selected image from the first plurality of images on the catalog page, at least one of the images from the second plurality of images aligns with the selected image from the first plurality of images to form an image of a complete object;
whereby images from the first and second plurality of images can be selectively combined to form an image of a complete object.

8. A system, as in claim 7, wherein:
the edges of the template page is trimmed such that the edges of the selected images arranged around the periphery of the template page are substantially on the edge of the template page;
whereby the template page is trimmed to allow the first and second images, when combined to form a complete object, to more accurately align with one another.

9. A system, as in claim 6, wherein:
the template page is fabricated from material which is substantially transparent; and
the second plurality of images arranged on the template page such that when the template page is placed on top of the catalog page, and an image from the catalog page is aligned with an image from the template page goes to images will create the image of a complete object;
whereby substantially all of the surface area of the template page is available to display images from the second plurality of images.

10. A system, as in claim 1, wherein:
the first plurality of images have a front edge, where the front edge joins the edge of an image from the second plurality of images, which forms a substantially straight line;
whereby the edges of the first plurality of images and the edges of the second plurality of images form a substantially straight line when joined together.

11. A catalog template system, further comprising:
a slide rule having a fixed catalog segment and a slidable template segment, wherein:
the fixed catalog segment having a first plurality of images, each image in the first plurality of images representing a first part of a complete object; and
the slidable template segment having a second plurality of images, the second plurality of images related to the first plurality of images, and each image in the second plurality of images representing a second part of a complete object; and
the slidable template segment slidably attached to the fixed catalog segment such that a selected image from the first plurality of images can be aligned with a selected image from the second plurality of images such that when the selected images are aligned together, they combine to create an image of a complete object;
whereby images from first and second pluralities of images can be selectively combined with one another to produce a number of images of complete objects.

12. A catalog template system, as in claim 11, wherein:
the slide rule has a linear structure in which the fixed catalog segment and the slidable template segment slide in a linear fashion in relation to one another.

13. A catalog template system, as in claim 11, wherein:
the slide rule has a circular structure in which the rear disk is attached to, and rotates in relation to, a front disk;
either the rear disk or the front disk contains the fixed catalog segment, and the other disk contains the slidable template segment.

14. A system, as in claim 11, wherein:
the first plurality of images have a front edge, where the front edge joins the edge of an image from the second plurality of images, which forms a substantially straight line;
whereby the edges of the first plurality of images and the edges of the second plurality of images form a substantially straight line when joined together.

15. A method of displaying the large volume of combinable items using a template system, including the steps of:
selecting a first image from a database having first plurality of images which represents combinable parts of a complete object, and selecting a second image from a database having a second plurality of images which represents combinable parts of the complete object, the first and second images related to each other, such that when combined, they form and image of the complete object;
displaying the image of the complete object;
selecting ordering information related to the complete object;
using the selected ordering information to place an order for the complete object;
whereby images from first and second pluralities of images can be selectively combined with one another such that the most desirable complete object is selected.

16. A method, as in claim 15, including the additional steps of:
photographing the first and second plurality of images such that the image of the complete object is substantially aligned at the front edge of the first plurality of images with the edge of an image from the second plurality of images, such that they are in substantial contact when displayed
whereby the edges of the first plurality of images and the edges of the second plurality of images form a substantially straight line when joined together.

17. A method, as in claim 16, including the additional steps of:
displaying the first plurality of images in the form of catalog pages; and
displaying the second plurality of images in the form of a template.

18. A method, as in claim 16, including the additional steps of:
displaying the first and second plurality of images in the form of computer images.

19. A method, as in claim 16, including the additional steps of:
displaying the first and second plurality of images on components of the slide rule.

20. A method, as in claim 15, including the additional steps of:
displaying the first and second plurality of images in the form of computer images.
